(19) United States
(12) Patent Application Publication
(10) Pub. No.: US 2010/0207574 A1
(43) Pub. Date: Aug. 19, 2010

(54) Energy Smart Charging System

(76) Inventor: Jorge Luis Ortiz-Nieves, Gurabo, PR (US)

Correspondence Address: EUGENIO J. TORRES, 221 PLAZA BUILDING, PONCE DE LEON, SUITE 403, SAN JUAN, PR, 00917, US

(21) Appl. No.: 12/372,824

(22) Filed: Feb. 18, 2009

(51) Int. Cl. H02J 7/00; H02K 53/00

(52) U.S. Cl. 320/103; 415/916

(57) ABSTRACT

A portable power supply system comprising several portable power sources coupled to a power supply charging circuit, wherein said power supply charging circuit comprises an inverter, a charger and a control unit that controls the portable power source delivery of energy in order to reduce damages to said portable power source.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The invention is related to an apparatus which prolongates the life of a portable power source of an energy power supply system, more particularly, a energy power supply system comprising a control unit that manages the portable power source energy charge and discharge in order to reduce damages to said portable power source.

2. Discussion of the Background

Currently the global warming due to pollution makes people be more concerned about the environment driving science to look for ways to protect it. On the search for protecting the environment alternate sources of energy had been created. For example portable energy sources such as batteries are the used alternative source of energy. The main purpose of portable energy sources is to provide energy when outages affect your home and/or to make easier the transportation and use of device electrical devices.

Improvements to portable energy in order to provide portable energy source more durable and efficient are known. Some improvements are rechargeable portable energy source recharged by renewable energy such as sunlight, wind, rain, tides and geothermal heat. Also is the use of different material that improves the portable energy source life. All this improves making the portable battery a non-pollution energy source or at least reduces contamination.

One of the difficulties of using portable energy power sources is the heat build up while the system is connected to a load. For example, U.S. Pat. No. 5,185,536 to Johson, Jr. et al. discloses an uninterrupted power supply (UPS) apparatus with a back-up battery and successively coupled rectifier, inverter and output filter circuits, having an improved battery charging circuit. The charging circuit has a transformer with its primary winding being part of the output filter, and its secondary winding driving a second rectifier circuit which produces the charging current. Johson discloses a improved battery charging circuit fails to provide a system that protect or reduce the heat at the portable energy source while is connected to a load.

Therefore there is a need for protecting the portable energy source from damages due to the heat build up while is connected to a load in order to extend the portable energy source life.

### SUMMARY OF THE INVENTION

The present invention overcomes the disadvantages of the Prior Art by providing a energy power supply system comprising a control unit that manages the portable power source energy charge and discharge in order to reduce damages to said portable power source.

Another object of the invention is to provide a more durable and efficient energy power supply system.

Another object of the invention is to provide a energy power supply system that supplies energy to a load while simultaneously charges a portable power source.

Yet another object of the present invention is to provide a energy power supply system that increases the portable power source life.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiment of the invention.

FIG. 1 shows the general circuit for the present invention

FIG. 2 shows the general circuit for the present invention and main terminals

FIG. 3 shows the present invention circuit with two portable power supplies.

FIG. 4 shows the terminals of the control unit for the present invention

### DESCRIPTION OF THE PREFERRED EMBODIMENT

The present invention is directed to a energy power supply system source 1 comprising several rechargeable portable power sources 3 coupled to a power supply charging circuit, wherein said power supply charging circuit comprises at least an inverter 2, a charger 6 and a control unit 5 that controls the portable power source delivery of energy in order extends the portable power source life and while reducing damages due to the heat that builds up at the portable power source 3 while the system 1 supplies energy to a connected load.

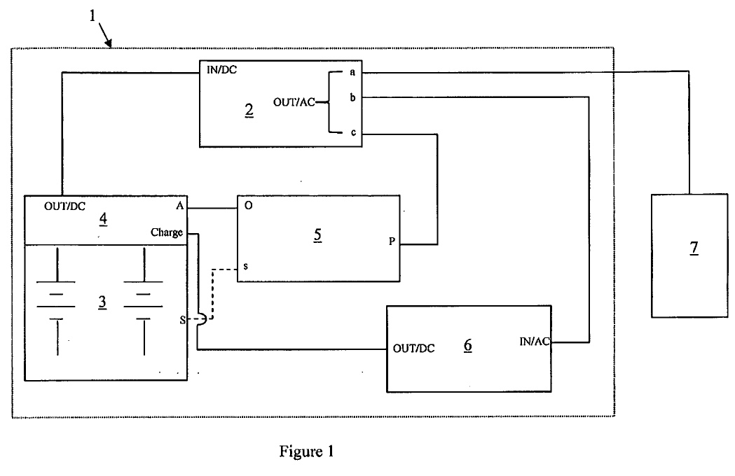

FIG. 1 discloses the general structure of the present invention, wherein a energy power supply system 1 comprises several portable power supplies 3, such as a bank of batteries, coupled to a power supply charging circuit wherein said power supply charging circuit 3 comprises an actuator 4 which manages the input and output of current as result of the operation commands or signals that receives from a control unit 5. The actuator output is connected to an inverter 2 that changes the dc current provided from the batteries 3 into AC current, wherein said inverter 2 is provided with at least three outputs a,b,c supplying power to a control unit 5, a charger 6 and a load 7. It has to be understood that more than one inverter 2 may be connected to the actuator output.

Further a charger 6 is connected to said actuator 4, which as mentioned before manages the input and output of current of the battery bank 3. The control unit 5 measures a variable of interest, such as temperature, voltage or any other variable from the battery bank 3 and processes said measure in order to provides a signal S′ or command that takes action by means of the actuator 4.

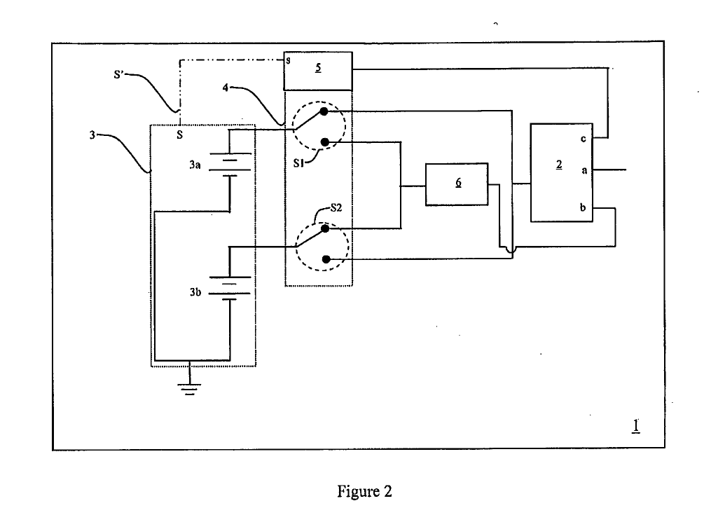

FIG. 2 clearly shows the battery bank 3, wherein said battery bank comprises at least two batteries 3a,3b connected in parallel to the actuator 4. As mentioned before, the actuator 4 manages the input and output of current at the battery bank 3. In the instance case the actuator 4 comprises electrical devices that can interrupt or divert the current between conductors. For example, the actuator 4 comprises switches S1,S2 activated by a control unit 5, wherein said switches interrupts or diverts the input and output current of the battery bank 3 between the charger 6 and inverter 2 which are electrically connected to said actuator 4. The battery bank 3 is provided with a sensor S for the measuring of a variable of interest, which generates an electrical signal S′ that is received by the control unit 5 though an input s. Depending on the measure result from the battery bank 3 a battery 3a,3b is charging while the other is delivering energy. The decision of which one of the batteries 3a,3b is delivering energy or charging directly depends of the control unit 5 evaluation after processing said variable of interest.

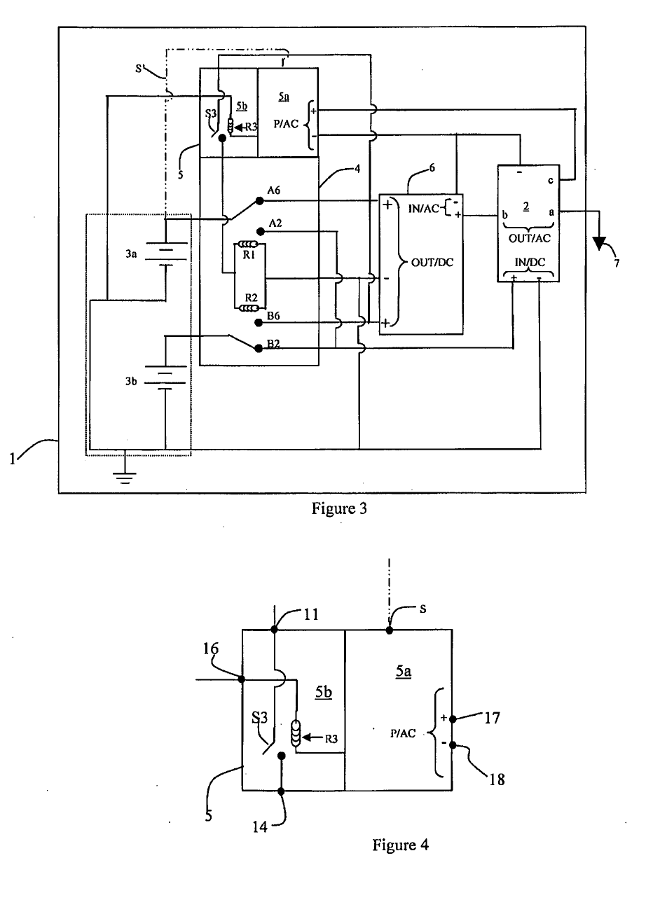

FIG. 3 and FIG. 4 show more clearly the control unit 5 and connection between the invention components. The batteries 3a,3b are connected to the actuator 4, more particularly to the switches at the actuator 4. In the instant case the battery 3a is connected to a electro-magnetic switch R1 which diverts the current between two terminals A6,A2, wherein the first terminal A6 connect the battery 3a with the charger for charging and the second terminal A2 connect said battery with the inverter 2 for current deliver. The second battery 3b is connected to the electro-magnetic switch R2 which also diverts the current between two terminals B6,B2, wherein the first terminal B6 connect the battery 3a with the charger for charging and the second terminal B2 connects said battery with the inverter 2 for current deliver. The relays R1,R2 are activated by an electrical signal from the control unit 5 which selects which battery is charging or delivering energy.

The control unit 5 comprises a integral circuit (IC) 5a wherein the process and measuring of the variable of interest take place and a signal generation portion 5b wherein the activation signal for the relays R1,R2 is generated. The inverter 2 provides energy to the IC 5a which measures the variable of interest, such as voltage at a battery 3a, and compares said value with some set up values, such as a minimum and/or maximum voltage. Depending on the results the IC 5a activates a relay R3 at the signal generation portion 5b which closes a switch S3 resulting in the activation of relays R1,R2. The IC 5a may be programmed for different values that are selected by the users or provided with switching delays.

When the system starts working the battery 3a is supplying energy while battery 3b is being charged simultaneously. During operation the system 1, as show in FIG. 3, is constantly monitoring the voltage through sensor S at battery 3a. If the IC 5a identifies that the value at said battery 3a drops to a value lower than the one set up the system 1 immediately activates the relay R3 at the signal generation portion 5b. These results in the activation of the actuator relays R1,R2. The activation of said relays R1,R2 generates a change in the connections and switches the system 1 from a first state to a second state wherein instead of the first battery 3a supplying energy and the second battery 3b charging, the first battery starts charging and the second starts supplying energy. The switching continues until the system 1 is not able to performed at the set up values. At this point the system provides a display indicating a battery change.

The switching of battery while supplying power to a load avoids damages due to heat at the portable power sources 3 and extends the battery life. Also it is preferred that the load 7 connected to the systems consumes less than the 65-85% of the total power delivered by the system 1. It is important to understand that the control unit disclosed above is not intended to limit the invention but moreover to provide an example of a control unit that controls and manages by means of a actuator the input and output of energy from the portable sources due to a variable of interest in such way that damages at the portable source can be prevent or reduce while supplying energy to a load.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. For example, providing more than two batteries at the battery bank. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A energy power system comprising;
several rechargeable portable power sources, a power supply charging circuit, wherein said power supply charging circuit is coupled to the portable power sources,
wherein said power supply charging circuit comprises at least an inverter, a charger and a control unit, wherein said control unit controls simultaneously the portable power sources charge and delivery of energy by means of an actuator.

2. A energy power system comprising as in claim 1, wherein said several portable power sources are batteries

3. A energy power system comprising as in claim 1, wherein said actuator manages the input and output of current at the portable power sources as result of an operation command received from a control unit 5

4. A energy power system comprising as in claim 1 wherein said control unit measures a variable at the portable power sources, compares said measured value with a pre-set value and generates a signal that activates the actuator, wherein said actuator diverts the portable power sources electrical connection with the charger and the inverter.

5. A energy power system comprising as in claim 1, wherein said control unit measures at least a variable at the portable power sources, compares said measured value with a pre-set value and generates a signal that activates the actuator, wherein said actuator diverts each portable power source electrical connection from the charger to the inverter or vice-versa.

6. A energy power system comprising as in claim 1 wherein said inverter switches the current flow supplied by selected portable power source from said several portable power sources and is connected to the portable power sources through the actuator, and wherein said charger charges selected portable power source from said several portable power sources and is connected to the portable power sources through the actuator.

7. A energy power system comprising as in claim 1 wherein said actuator comprises electromagnetic switches diverting each portable power source electrical connection from the charger to the inverter or vice-versa.

8. A energy power system comprising;
several portable power sources,
a power supply charging circuit, wherein said power supply charging circuit is coupled to the portable power sources,
wherein said power supply charging circuit comprises at least an inverter, a charger and a control unit,
wherein said inverter switches the current flow supplied by selected portable power source from said several portable power sources and is connected to the portable power sources through the actuator,
wherein said charger charges selected portable power source from said several portable power sources and is connected to the portable power sources through the actuator, and
wherein said control unit measures at least a variable at the portable power sources, compares said measured value with a pre-set value and generates a signal that activates the actuator, wherein said actuator diverts each portable power source electrical connection from the charger to the inverter or vice-versa controlling simultaneously said portable power sources charge and delivery of energy by means of said actuator.

9. A energy system comprising as in claim 8,
wherein said actuator comprises electromagnetic switches diverting each portable power source electrical connection from the charger to the inverter or vice-versa.

10. A control unit with actuator comprising
a integral circuit,
a signal generation portion,
several power sources,
a sensor,
wherein said signal generation portion is electrically connected to the integral circuit,
wherein said sensor measures a variable at a power source of said several power sources and converts it into a signal,
wherein said integral circuit compares said signal with a pre-set value and generates a command at said signal generation portion that activates an actuator, wherein said actuator diverts several power sources electrical connections from a first state to a second state due to said command.

11. A energy system comprising as in claim 10 wherein said first state comprises a first selected power source connected to a charger and a second selected power source connected to an inverter, and wherein the second state comprises said first selected power source electrical connected to said inverter and said second selected power source electrical connected to said charger.

12. A energy system comprising as in claim 11 wherein said actuator comprises electromagnetic switches diverting each power source electrical connection from the charger to the inverter or vice-versa.
